(19) United States
(12) Patent Application Publication
(10) Pub. No.: US 2026/0065029 A1
(43) Pub. Date: Mar. 5, 2026

(54) SYSTEMS AND METHODS FOR PERTURBATION-BASED ZERO-SHOT HALLUCINATION REASONING FOR LARGE LANGUAGE MODEL GENERATED TEXT

(71) Applicant: JPMORGAN CHASE BANK, N.A., New York, NY (US)

(72) Inventors: Seongmin LEE, Atlanta, GA (US); Hsiang HSU, Boston, MA (US); Richard CHEN, Baldwin Place, NY (US)

(21) Appl. No.: 18/819,431

(22) Filed: Aug. 29, 2024

(51) Int. Cl. G06N 3/047; G06F 40/284; G06F 40/295; G06F 40/30; G06F 40/40

(52) U.S. Cl. CPC G06N 3/047; G06F 40/284; G06F 40/295; G06F 40/30; G06F 40/40

(57) ABSTRACT

A method may include: receiving a prompt and generated text from the LLM; computing an original token probability distribution for each token in the prompt and in the generated text; receiving a token position probability distribution for each token position in the generated text from the LLM; identifying keywords in the prompt; perturbing embedding vectors for the keywords used by the LLM by adding noise to the embedding vectors; computing a perturbed probability distribution for the perturbed embedding vectors by providing the perturbed embedding vectors as an input to a neural network used by the LLM, wherein the neural network returns a perturbed token probability distribution; evaluating a divergence between the original token probability distribution and the perturbed token probability distribution; identifying semantically meaningful tokens in the generated text; calculating a mean of divergences for the semantically meaningful tokens; and classifying the LLM based on the mean of divergences.

### BACKGROUND OF THE INVENTION

### 1. Field of the Invention

Embodiments are generally directed to systems and methods for perturbation-based zero-shot hallucination reasoning for large language model generated text.

### 2. Description of the Related Art

Large-Language Models, or LLMs, tend to perceive patterns or objects that are nonexistent, creating nonsensical or inaccurate outputs. These are often referred to as “hallucinations.” This is because LLMs are trained to fabricate plausible text even when they are incapable of answering the prompt.

A LLM consists of three components: (1) a tokenizer, (2) a token embedding map that contains an embedding vector (i.e., a numerical representation) for each token, and (3) neural network. The LLM may generate text using an iterative process of predicting what token should appear after the input text (initially a prompt), adding the predicted token after the input text, feeding the “input text and added token” as input to the model, and repetitively predicting the token that should appear next.

A LLM first takes a text prompt as an input and predicts which token should appear after the prompt. The prediction consists of five steps: (1) splitting the prompt into tokens using a tokenizer, (2) converting the tokens into embedding vectors using the token embedding map, (3) processing the embedding vectors using neural network, (4) converting the output of the neural network into probability distribution across all possible tokens, and (5) sampling a token based on the probability distribution and add the sampled token after the prompt.

For each position, a token may be sampled based on the probability distribution; the token with the highest probability is highly likely to be generated. There is, however, some possibility of other tokens being generated.

Because the text generation is a probabilistic process, a LLM predicts the probability of each token to come next and samples a token based on the probability. Thus, there is a possibility to sample a token with low probability, which can end up generating unexpected text.

### SUMMARY OF THE INVENTION

Systems and methods for perturbation-based zero-shot hallucination reasoning for large language model generated text are disclosed. According to an embodiment, a method may include: (1) receiving, by a computer program, a prompt provided to a large language model, and generated text from the large language model; (2) computing, by the computer program and using the large language model, an original token probability distribution for each token in the prompt and in the generated text; (3) determining, by the computer program, a token position probability distribution for each token position in the generated text by providing the prompt and the generated text to the large language model, wherein the large language model returns the token position probability distribution for each token position in the generated text for tokens that are available to the large language model; (4) identifying, by the computer program, one or more keywords in the prompt; (5) perturbing, by the computer program, embedding vectors for the one or more keywords used by the large language model by adding noise to the embedding vectors; (6) computing, by the computer program, a perturbed probability distribution for the perturbed embedding vectors by providing the perturbed embedding vectors to a neural network used by the large language model as an input, wherein the neural network returns a perturbed token probability distribution; (7) evaluating, by the computer program, a divergence between the original token probability distribution and the perturbed token probability distribution; (8) identifying, by the computer program, semantically meaningful tokens in the generated text; (9) calculating, by the computer program, a mean of divergences for the semantically meaningful tokens; and (10) classifying, by the computer program, the large language model based on the mean of divergences.

In one embodiment, the keywords may include a named entity.

In one embodiment, the computer program selects one of a plurality of named entities as the keyword based on an amount of attention for each of the named entity by the large language model.

In one embodiment, the noise may include Gaussian noise.

In one embodiment, the divergence may be a Kullback-Leibler divergence.

In one embodiment, the semantically meaningful tokens may include nouns, proper nouns, verbs, and adjectives.

In one embodiment, the large language model may be classified by comparing the mean of the divergences to a divergence threshold, wherein the divergence threshold may be based on a Kolmogorov-Smirnov (KS) test run on a validation data set.

In one embodiment, the method may also include: evaluating, by the computer program, a negative log-likelihood for each semantically meaningful token in response to the mean of the divergences being less than the divergence threshold.

In one embodiment, the method may also include: retraining, by the computer program, the large language model in response to a negative log-likelihood being below a negative log-likelihood threshold, wherein the negative log-likelihood may be based on a Kolmogorov-Smirnov (KS) test run on the validation data set.

In one embodiment, the method may also include: classifying, by the computer program, the large language model as having no hallucinations in response to a negative log-likelihood being above a negative log-likelihood threshold.

According to another embodiment, a non-transitory computer readable storage medium may include instructions stored thereon, which when read and executed by one or more computer processors, cause the one or more computer processors to perform steps comprising: receiving a prompt provided to a large language model, and generated text from the large language model; computing, using the large language model, an original token probability distribution for each token in the prompt and in the generated text; determining a token position probability distribution for each token position in the generated text by providing the prompt and the generated text to the large language model, wherein the large language model returns the token position probability distribution for each token position in the generated text tokens that are available to the large language model; identifying one or more keywords in the prompt; perturbing embedding vectors for the one or more keywords used by the large language model by adding noise to the embedding vectors; computing a perturbed probability distribution for the perturbed embedding vectors by providing the perturbed embedding vectors to a neural network used by the large language model as an input, wherein the neural network returns a perturbed token probability distribution; evaluating divergence between the original token probability distribution and the perturbed token probability distribution; identifying semantically meaningful tokens in the generated text; calculating a mean of divergences for the semantically meaningful tokens; and classifying the large language model based on the mean of divergences.

In one embodiment, the keywords may include a named entity.

In one embodiment, the one of a plurality of named entities may be selected as the keyword based on an amount of attention for each of the named entity by the large language model.

In one embodiment, the noise may include Gaussian noise.

In one embodiment, the divergence may be a Kullback-Leibler divergence.

In one embodiment, the semantically meaningful tokens may include nouns, proper nouns, verbs, and adjectives.

In one embodiment, the large language model may be classified by comparing the mean of the divergences to a divergence threshold, wherein the divergence threshold may be based on a Kolmogorov-Smirnov (KS) test run on a validation data set.

In one embodiment, the non-transitory computer readable storage medium may also include instructions stored thereon, which when read and executed by the one or more computer processors, cause the one or more computer processors to perform steps comprising: evaluating a negative log-likelihood for each semantically meaningful token in response to the mean of the divergences being less than the divergence threshold, wherein the negative log-likelihood may be based on a Kolmogorov-Smirnov (KS) test run on the validation data set.

In one embodiment, in response to the negative log-likelihood being below a negative log-likelihood threshold, the large language model may be retrained.

In one embodiment, in response to the negative log-likelihood being above a negative log-likelihood threshold, the large language model may be classified as having no hallucinations.

### BRIEF DESCRIPTION OF THE DRAWINGS

For a more complete understanding of the present invention, the objects and advantages thereof, reference is now made to the following descriptions taken in connection with the accompanying drawings in which:

FIG. 1 illustrates a system for perturbation-based zero-shot hallucination reasoning for large language model generated text according to an embodiment;

FIGS. 2A and 2B illustrate a method for perturbation-based zero-shot hallucination reasoning for large language model generated text according to an embodiment; and

FIG. 3 depicts an exemplary computing system for implementing aspects of the present disclosure.

### DETAILED DESCRIPTION OF PREFERRED EMBODIMENTS

Systems and methods for perturbation-based zero-shot hallucination reasoning for large language model generated text are disclosed.

Embodiments may identify whether LLM text is a hallucination and may also understand the reason for the hallucination. In general, given a LLM and LLM-generated text, embodiments may reveal whether the LLM-generated text is hallucinated and, if so, what the reason for the hallucination is.

There are three types of LLM-generated text: (1) correct, which indicates that the LLM has the knowledge relevant to the prompt, and the generated text aligns with it; (2) a mistake, which indicates that the LLM has the knowledge, but the text does not align with its knowledge; and (3) a fabrication, which indicates that the LLM does not have enough knowledge to respond to the prompt, and fabricates the response. The type of LLM-generated text is important so that the LLM can be trusted, needs to be regenerated or retrained, or should not be used. It is, however, difficult to determine, based on the output alone, the type of LLM-generated text.

Embodiments may thus perform a model knowledge test, which determines whether the LLM has sufficient knowledge to answer the prompt. The determination as to whether the LLM has sufficient knowledge may be based on a divergence threshold. If the LLM does not have sufficient knowledge, then the model knowledge test determines that the LLM-generated text is a fabrication. If the LLM does have sufficient knowledge, then embodiments may perform an alignment test to determine whether the LLM-generated text is consistent with, or aligns with, the LLM's knowledge. If the LLM-generated text does align with the LLM's knowledge, the LLM-generated text is correct, and not a hallucination. If the LLM-generated text does not align with the LLM's knowledge, then the LLM-generated text is a mistake.

Depending on the reason for the hallucination, embodiments may regenerate the LLM (e.g., if sampling was the reason), or may inform the user that the LLM is incapable of answering the prompt.

If the LLM-generated text is correct, then confidence in the LLM may be increased. For example, statistics on the LLM may be maintained, and may be adjusted based on a result of text generation.

In embodiments, the model knowledge test may assume that (1) all factual questions have the keyword (subject) of the question, and (2) if LLM did not base its knowledge on generating the text, perturbing keywords would have little impact on the generation. Thus, the model knowledge test may identify keywords in a piece of text by keyword detection techniques and perturb the embedding of those keywords by adding noise. It may then perform a hypothesis test on the perturbed text to discriminate different hallucination types.

Embodiments may use an alignment test to determine if the LLM-generated text is a hallucination. Embodiments may evaluate the negative log-likelihood (NLL) of each token in the LLM-generated text, or the negative log of the probability of the token to be generated. A high NLL indicates that the token should not be present, and an error occurred during sampling.

Based on the type of LLM-generated text, the LLM may be trusted, or an appropriate action, such as regenerating the LLM, re-training the LLM with additional knowledge, nor not using the LLM for the subject matter, may be taken.

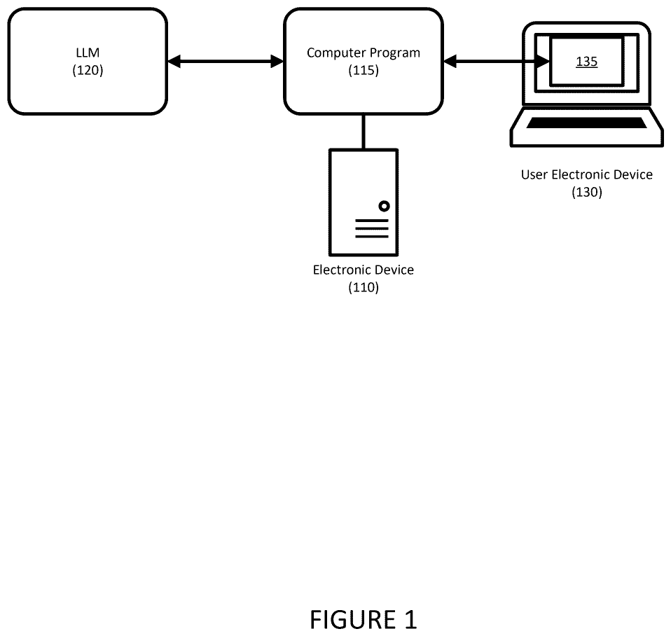

Referring to FIG. 1, a system for perturbation-based zero-shot hallucination reasoning for large language model generated text is disclosed according to an embodiment. System 100 may include electronic device 110, which may be a server (e.g., physical and/or cloud-based), a computer (e.g., a workstation, a desktop, a laptop, a notebook, a tablet, etc.), etc. Electronic device 110 may execute computer program 115, such as a hallucination detection computer program.

Computer program 115 may evaluate text generated by LLM 120. In FIG. 1, only one LLM is illustrated; it should be recognized that multiple LLMs may be provided, including LLMs executed over a computer network.

System 100 may further include user electronic device 130, which may be a computer, a smart device (e.g., smartphone, smart watch, etc.), an Internet of Things appliance, etc. User electronic device 130 may execute user computer program 135, which may receive and output the results of the analysis by computer program 125.

User computer program 135 may also issue prompts to LLM 120.

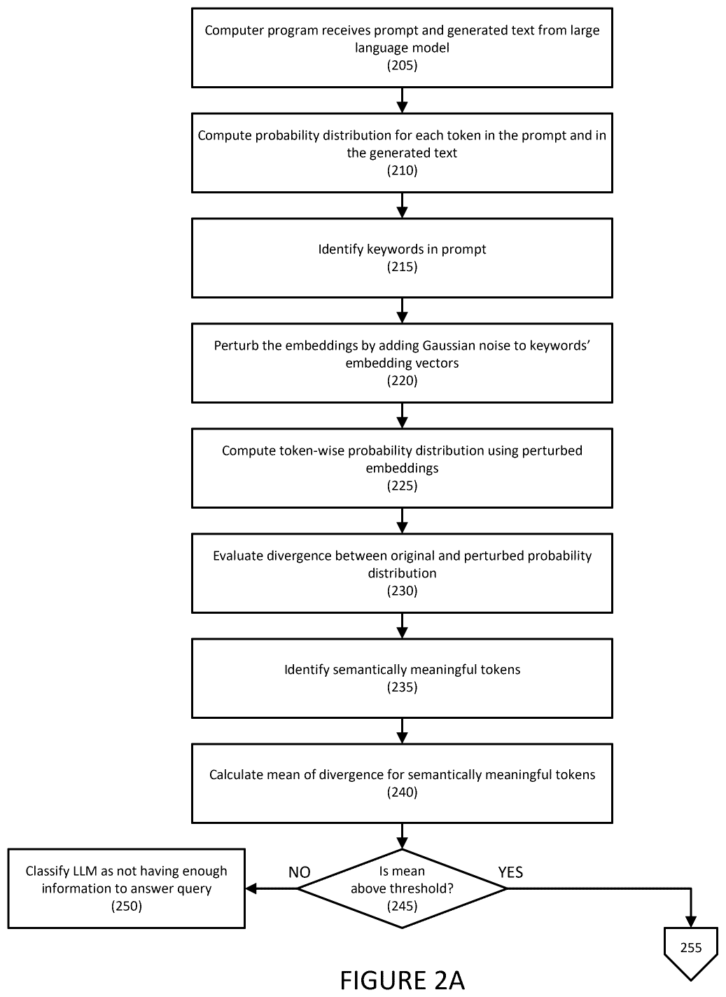

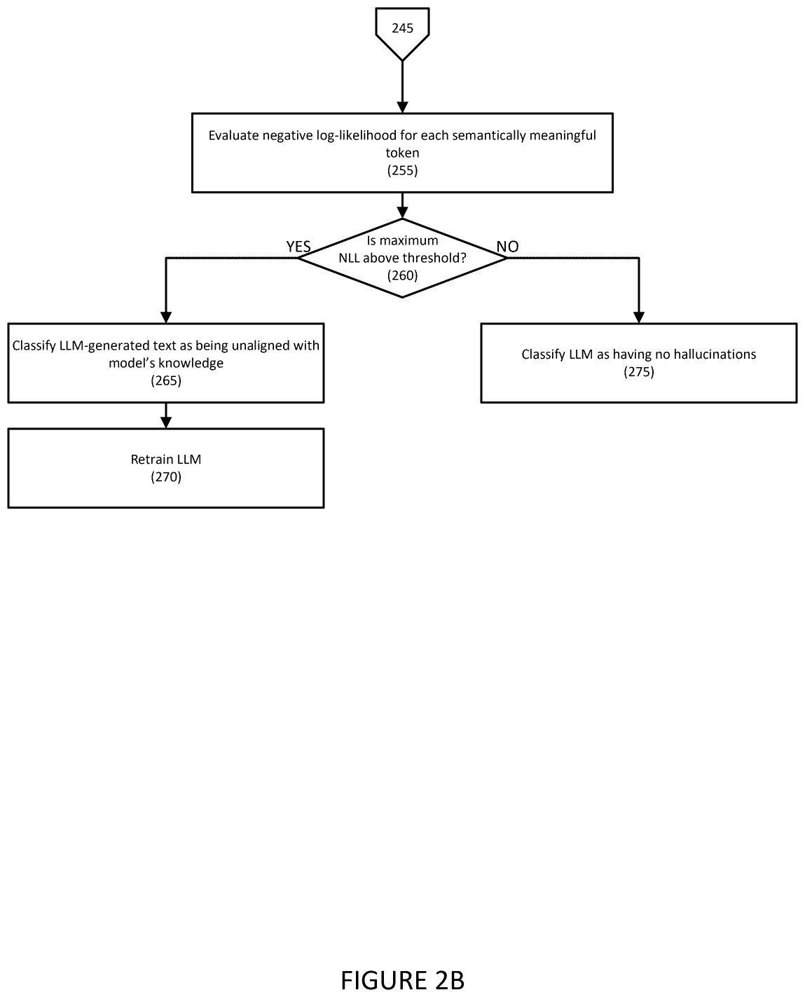

Referring to FIGS. 2A and 2B, a method for perturbation-based zero-shot hallucination reasoning for large language model generated text is disclosed according to an embodiment.

In step 205, a computer program, such as a hallucination detection computer program, may receive a prompt and generated text from a LLM. Any suitable LLM may be used. In one embodiment, the prompt may be submitted to the LLM by a user. An example of a prompt may be “Tell me a bio of Harrison Ford.” An example of LLM-generated text is “Harrison Ford is an American actor known for his roles in films such as ‘Indiana Jones,’ . . . ”.

The LLM may split the prompt into tokens using a tokenizer, may convert the tokens into embedding vectors using a token embedding map, may process the embedding vectors using a neural network, such as a neural network built on a transformer architecture, that may return logits (i.e., a vector of numbers that may be used for classification), and may use the logits to build a probability distribution of the tokens (e.g., words) that are available to the LLM. The LLM may select the token having the highest probability.

In step 210, the computer program may compute a probability distribution for each token (e.g., a word) in the prompt and the generated text, and may determine the probability distribution for each token position in the generated text. For example, the computer program may provide the “prompt+generated text” (i.e., the concatenation of the prompt and generated text) to a LLM, which may be the same LLM that generated the generated text, or it may be a different LLM. The LLM may return a probability distribution across all possible tokens available to the LLM for each token position in the generated text.

In step 215, the computer program may identify keywords, such as the subject, in the prompt. In one embodiment, the computer program may identify named entities (e.g., names, places, dates, etc.) in a sentence. If there is only one named entity, that entity may be used as the keyword.

If there are more than one named entity, the computer program may evaluate the amount that each named entity is attended by the LLM while generating the “generated text”. The attention of each named entity may be easily evaluated as most LLMs have transformer-based architecture, a deep learning architecture whose computations are based on the importance of each token; by summing up the importance of the tokens of each named entity, the computer program may evaluate the attention of the named entity. The named entity having the highest attention by the model may be used as the keyword.

In step 220, the computer program may perturb, distort, or otherwise modify the embeddings by adding noise to the keywords'embedding vectors. This may be done to perform a model knowledge test. For example, the noise may be Gaussian noise that has a standard deviation of 0.1; other standard deviations may be used. The addition of the noise slightly alters the token embeddings for the keywords (e.g., “Harrison Ford” may be perturbed to be “Harry Tord”). The standard deviation controls the magnitude of the generated perturbation. If a larger perturbation is used, a greater value for the standard deviation may be used.

The embedding vectors may be from the embedding map used by the LLM. For example, the keywords may be treated as tokens, and their embedding vectors may be looked up in a mapping table. Noise may then be added to the embedding vectors.

In step 225, the computer program may compute a perturbed probability distribution using the perturbed embeddings. For example, the perturbed embeddings may be provided to the neural network of the LLM as an input. Then, the perturbed embeddings are processed by the neural network and converted into the perturbed probability distribution.

For example, as the perturbed embeddings are generated, they may be provided to the neural network as an input.

In one embodiment, the neural network that is used may be from the same LLM that generated the text, or it may be from a different LLM. This may be useful, for example, for generic knowledge.

In step 230, the computer program may evaluate a divergence between the original probability distribution and the perturbed probability distribution. The divergence measures the effect of the addition of the noise on the LLM-generated text. A larger divergence indicates a larger impact of the noise on the LLM-generated text, which indicates that the LLM-generated text is likely fabricated text.

For example, for each token position, there are two types of probability distributions: (1) the original probability distribution which represents the probability of each token to appear at the position (token-wise probability) and (2) the perturbed probability distribution which represents the token-wise probability with the perturbed token. To evaluate the divergence, for each token position, in one embodiment, the Kullback-Leibler (KL) divergence of the original and perturbed probability distributions may be calculated; other divergences may be used as is necessary and/or desired.

The KL divergence may be used to measure the difference between the probability distributions of two tokens. For example, if the number of all possible tokens is 50000, then the probability distribution of a token is a vector with 50000 entries, and the sum of all the entries equals to 1. Each value on the vector corresponds to the probability that a token could be chosen. The KL divergence is computed using two such vectors.

The divergence of the two probability distributions is a single value. For example, the divergence may be evaluated for each token position, which would give the N numbers of divergence values, where N is the number of tokens in the generated text. A larger divergence means greater impact of the perturbation.

In step 235, the computer program may identify semantically meaningful tokens in the generated text. For example, the computer program may tag the part of speech of each token in the text (i.e., it may identify which token is for noun, verb, etc.), and the tokens for nouns, proper nouns, verbs, and adjectives may be used as semantically meaningful tokens. Notably, semantically meaningful tokens are often hallucinated.

In step 240, the computer program may calculate, for example, the mean, or average, of the divergences for the semantically meaningful tokens. As N number of divergences are calculated, they may be integrated into a single value.

In step 245, the computer program may evaluate the mean relative to a divergence threshold. If the mean is below the divergence threshold, in step 250, the computer program may classify the LLM as not having enough information to answer a query.

In one embodiment, a Kolmogorov-Smirnov (KS) test may be run on a validation data set to determine the divergence threshold. The KS test may be used to test whether a sample same from a reference probability distribution. In one embodiment, the validation dataset may include text and labels that may be used to determine if the LLM has sufficient knowledge to confidently generate the text. Thus, the divergence threshold may be based on the value that performs the best on the validation data set.

If the mean is above the divergence threshold, in step 255, the computer program may evaluate the negative log-likelihood (NLL) for each semantically meaningful token. The NLL for each token is the negative of the log of the probability that the semantically meaningful token will generated.

In step 260, the computer program may evaluate the maximum NLL relative to a NLL threshold. The NLL threshold may also be based on the validation set of data, and the KS test. For example, the KS test may also be run on the validation dataset to determine the NLL threshold. By running KS test on the validation set, the NLL threshold value that performs best (measured by the Area Under Curve) on the validation set may be used as the threshold.

The validation dataset may be the same validation dataset used to identify the divergence threshold, or it may be a different validation dataset.

If the maximum NLL is above the NLL threshold, indicating that the token should not be present, in step 265, the computer program may classify the LLM-generated text as being unaligned with the LLM's knowledge. In step 270, the computer program may retrain the LLM. This indicates that there was an error during sampling.

If the NLL is not above the NLL threshold, in step 275, the computer program may classify the LLM as having no hallucinations. This increases the confidence in the LLM. The confidence may be reported to the user, or it may be tracked for the LLM in its product development cycle.

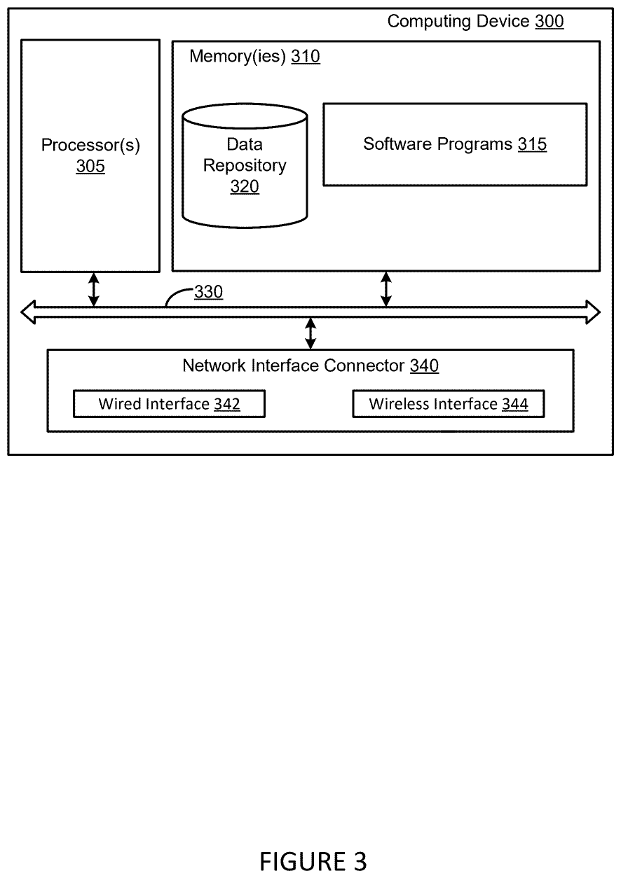

FIG. 3 depicts an exemplary computing system for implementing aspects of the present disclosure. FIG. 3 depicts exemplary computing device 300. Computing device 300 may represent the system components described herein. Computing device 300 may include processor 305 that may be coupled to memory 310. Memory 310 may include volatile memory. Processor 305 may execute computer-executable program code stored in memory 310, such as software programs 315. Software programs 315 may include one or more of the logical steps disclosed herein as a programmatic instruction, which may be executed by processor 305. Memory 310 may also include data repository 320, which may be nonvolatile memory for data persistence. Processor 305 and memory 310 may be coupled by bus 330. Bus 330 may also be coupled to one or more network interface connectors 340, such as wired network interface 342 or wireless network interface 344. Computing device 300 may also have user interface components, such as a screen for displaying graphical user interfaces and receiving input from the user, a mouse, a keyboard and/or other input/output components (not shown).

Hereinafter, general aspects of implementation of the systems and methods of embodiments will be described.

Embodiments of the system or portions of the system may be in the form of a “processing machine,” such as a general-purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above. Such a set of instructions for performing a particular task may be characterized as a program, software program, or simply software.

In one embodiment, the processing machine may be a specialized processor.

In one embodiment, the processing machine may be a cloud-based processing machine, a physical processing machine, or combinations thereof.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement embodiments may be a general-purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA (Field-Programmable Gate Array), PLD (Programmable Logic Device), PLA (Programmable Logic Array), or PAL (Programmable Array Logic), or any other device or arrangement of devices that is capable of implementing the steps of the processes disclosed herein.

The processing machine used to implement embodiments may utilize a suitable operating system.

It is appreciated that in order to practice the method of the embodiments as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above, in accordance with a further embodiment, may be performed by a single component. Further, the processing performed by one distinct component as described above may be performed by two distinct components.

In a similar manner, the memory storage performed by two distinct memory portions as described above, in accordance with a further embodiment, may be performed by a single memory portion. Further, the memory storage performed by one distinct memory portion as described above may be performed by two memory portions.

Further, various technologies may be used to provide communication between the various processors and/or memories, as well as to allow the processors and/or the memories to communicate with any other entity, i.e., so as to obtain further instructions or to access and use remote memory stores, for example. Such technologies used to provide such communication might include a network, the Internet, Intranet, Extranet, a LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of embodiments. The set of instructions may be in the form of a program or software. The software may be in the form of system software or application software, for example. The software might also be in the form of a collection of separate programs, a program module within a larger program, or a portion of a program module, for example. The software used might also include modular programming in the form of object-oriented programming. The software tells the processing machine what to do with the data being processed.

Further, it is appreciated that the instructions or set of instructions used in the implementation and operation of embodiments may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments. Also, the instructions and/or data used in the practice of embodiments may utilize any compression or encryption technique or algorithm, as may be desired. An encryption module might be used to encrypt data. Further, files or other data may be decrypted using a suitable decryption module, for example.

As described above, the embodiments may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in embodiments may take on any of a variety of physical forms or transmissions, for example. Illustratively, the medium may be in the form of a compact disc, a DVD, an integrated circuit, a hard disk, a floppy disk, an optical disc, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors.

Further, the memory or memories used in the processing machine that implements embodiments may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the systems and methods, a variety of “user interfaces” may be utilized to allow a user to interface with the processing machine or machines that are used to implement embodiments. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method, it is not necessary that a human user actually interact with a user interface used by the processing machine. Rather, it is also contemplated that the user interface might interact, i.e., convey and receive information, with another processing machine, rather than a human user. Accordingly, the other processing machine might be characterized as a user. Further, it is contemplated that a user interface utilized in the system and method may interact partially with another processing machine or processing machines, while also interacting partially with a human user.

It will be readily understood by those persons skilled in the art that embodiments are susceptible to broad utility and application. Many embodiments and adaptations of the present invention other than those herein described, as well as many variations, modifications and equivalent arrangements, will be apparent from or reasonably suggested by the foregoing description thereof, without departing from the substance or scope.

Accordingly, while the embodiments of the present invention have been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications or equivalent arrangements.

What is claimed is:

1. A method, comprising:
receiving, by a computer program, a prompt provided to a large language model, and generated text from the large language model;
computing, by the computer program and using the large language model, an original token probability distribution for each token in the prompt and in the generated text;
determining, by the computer program, a token position probability distribution for each token position in the generated text by providing the prompt and the generated text to the large language model, wherein the large language model returns the token position probability distribution for each token position in the generated text for tokens that are available to the large language model;
identifying, by the computer program, one or more keywords in the prompt;
perturbing, by the computer program, embedding vectors for the one or more keywords used by the large language model by adding noise to the embedding vectors;
computing, by the computer program, a perturbed probability distribution for the perturbed embedding vectors by providing the perturbed embedding vectors to a neural network used by the large language model as an input, wherein the neural network returns a perturbed token probability distribution;
evaluating, by the computer program, a divergence between the original token probability distribution and the perturbed token probability distribution;
identifying, by the computer program, semantically meaningful tokens in the generated text;
calculating, by the computer program, a mean of divergences for the semantically meaningful tokens; and
classifying, by the computer program, the large language model based on the mean of divergences.

2. The method of claim 1, wherein the keywords comprise a named entity.

3. The method of claim 1, wherein the computer program selects one of a plurality of named entities as the keyword based on an amount of attention for each of the named entity by the large language model.

4. The method of claim 1, wherein the noise comprises Gaussian noise.

5. The method of claim 1, wherein the divergence is a Kullback-Leibler divergence.

6. The method of claim 1, wherein a first semantically meaningful token of the semantically meaningful tokens comprises a noun, a proper noun, a verbs, or an adjective.

7. The method of claim 1, wherein the large language model is classified by comparing the mean of the divergences to a divergence threshold, wherein the divergence threshold is based on a Kolmogorov-Smirnov (KS) test run on a validation data set.

8. The method of claim 7, further comprising:
evaluating, by the computer program, a negative log-likelihood for each semantically meaningful token in response to the mean of the divergences being less than the divergence threshold.

9. The method of claim 8, further comprising:
retraining, by the computer program, the large language model in response to a negative log-likelihood being below a negative log-likelihood threshold, wherein the negative log-likelihood is based on a Kolmogorov-Smirnov (KS) test run on the validation data set.

10. The method of claim 8, further comprising:
classifying, by the computer program, the large language model as having no hallucinations in response to a negative log-likelihood being above a negative log-likelihood threshold.

11. A non-transitory computer readable storage medium, including instructions stored thereon, which when read and executed by one or more computer processors, cause the one or more computer processors to perform steps comprising:
receiving a prompt provided to a large language model, and generated text from the large language model;
computing, using the large language model, an original token probability distribution for each token in the prompt and in the generated text;
determining a token position probability distribution for each token position in the generated text by providing the prompt and the generated text to the large language model, wherein the large language model returns the token position probability distribution for each token position in the generated text for tokens that are available to the large language model;
identifying one or more keywords in the prompt;
perturbing embedding vectors for the one or more keywords used by the large language model by adding noise to the embedding vectors;
computing a perturbed probability distribution for the perturbed embedding vectors by providing the perturbed embedding vectors to a neural network used by the large language model as an input, wherein the neural network returns a perturbed token probability distribution;
evaluating divergence between the original token probability distribution and the perturbed token probability distribution;
identifying semantically meaningful tokens in the generated text;
calculating a mean of divergences for the semantically meaningful tokens; and
classifying the large language model based on the mean of divergences.

12. The non-transitory computer readable storage medium of claim 11, wherein the keywords comprise a named entity.

13. The non-transitory computer readable storage medium of claim 11, wherein the one of a plurality of named entities is selected as the keyword based on an amount of attention for each of the named entity by the large language model.

14. The non-transitory computer readable storage medium of claim 11, wherein the noise comprises Gaussian noise.

15. The non-transitory computer readable storage medium of claim 11, wherein the divergence is a Kullback-Leibler divergence.

16. The non-transitory computer readable storage medium of claim 11, wherein a first semantically meaningful token of the semantically meaningful tokens comprises a noun, a proper noun, a verbs, or an adjective.

17. The non-transitory computer readable storage medium of claim 11, wherein the large language model is classified by comparing the mean of the divergences to a divergence threshold, wherein the divergence threshold is based on a Kolmogorov-Smirnov (KS) test run on a validation data set.

18. The non-transitory computer readable storage medium of claim 17, further comprising instructions stored thereon, which when read and executed by the one or more computer processors, cause the one or more computer processors to perform steps comprising:
evaluating a negative log-likelihood for each semantically meaningful token in response to the mean of the divergences being less than the divergence threshold, wherein the negative log-likelihood is based on a Kolmogorov-Smirnov (KS) test run on the validation data set.

19. The non-transitory computer readable storage medium of claim 18, wherein, in response to the negative log-likelihood being below a negative log-likelihood threshold, the large language model is retrained.

20. The non-transitory computer readable storage medium of claim 18, wherein, in response to the negative log-likelihood being above a negative log-likelihood threshold, the large language model is classified as having no hallucinations.
